(19) United States
(12) Patent Application Publication
(10) Pub. No.: US 2018/0053444 A1
(43) Pub. Date: Feb. 22, 2018

(54) BAND IDENTIFYING SYSTEM

(71) Applicant: Joel Houghton-Renyard, Whitecourt (CA)

(72) Inventor: Joel Houghton-Renyard, Whitecourt (CA)

(21) Appl. No.: 15/240,717

(22) Filed: Aug. 18, 2016

(51) Int. Cl. G09F 3/00

(52) U.S. Cl. CPC G09F 3/0295; G09F 2003/0251

(57) ABSTRACT

A band identifying system for labeling hoses that contain or may have contained hazardous substances. The band identifying system may wrap around the middle of a hose and serve as a last contained labeling band. The device may be used on hoses during transport or while substances are being stored on a vehicle. The device promotes a safe work environment.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of labeling means and more specifically relates to a band identifying system entitled, “LC Bands”.

### 2. DESCRIPTION OF RELATED ART

Dangerous goods or hazardous goods are solids, liquids, or gases that can harm people, other living organisms, property, or the environment. They are often subject to chemical regulations. In the United States, United Kingdom and sometimes in Canada, dangerous goods are more commonly known as hazardous materials (abbreviated as HAZMAT or hazmat). Hazmat teams are personnel specially trained to handle dangerous goods, which include materials that are radioactive, flammable, explosive, corrosive, oxidizing, asphyxiating, biohazardous, toxic, pathogenic, or allergenic. Also included are physical conditions such as compressed gases and liquids or hot materials, including all goods containing such materials or chemicals, or may have other characteristics that render them hazardous in specific circumstances. Hazardous goods need to be transported for various reasons. Explosions and other accidents occur when safety precautions are not taken during the handling of such hazardous materials. A suitable solution is desired.

Several attempts have been made to solve the above-mentioned problems such as those found in U.S. Pat. No. 6,079,135 to Timothy P. Ruiz; U.S. Pat. No. 7,194,829 to Martin C. Boire; U.S. Pat. No. 5,311,688 to John A Giovanini; U.S. Pat. No. 5,138,784 to Joseph T. R. Niwa; U.S. Pat. No. 4,430,816 to Fenmore R. Seton; U.S. Pat. No. 4,246,712 to James A. Vander Wall; U.S. Pat. No. 2,188,710 to John A Giovanini; and U.S. Pat. No. 1,960,748 to Meunier Roland J; U.S. Pub Nos. 2008/0098637 to Dwight Pratt; and 2013/0284299 to Nicholas Clancy Schooley, et al. This art is representative of labeling means. However, none of the above inventions and patents, taken either singly or in combination, is seen to describe the invention as claimed.

### BRIEF SUMMARY OF THE INVENTION

In view of the foregoing disadvantages inherent in the known labeling means art, the present invention provides a novel band identifying system. The general purpose of the present invention, which will be described subsequently in greater detail is to provide a label for identifying at least one hose and regulating a hazardous substance residing in the hose and promote a safe work environment.

A band identifying system is disclosed herein, in a preferred embodiment, comprising: a band identifying assembly having a band, a label, and a fastener. The band identifying system comprises the band identifying assembly. The band identifying assembly comprises the band, the label, and the fastener in functional combination for use. The label is located on the band for readily identifying contents of at least one hose. The fastener is configured to wrap around the at least one hose. The fastener may comprise a watch-like clip or other such appropriate fastening means. The band identifying assembly identifies the hazardous substance and shows a last contained and currently contained substance. The band identifying assembly follows transportation of dangerous goods regulations to promote safety when the dangerous goods are being handled. The band identifying assembly complies with workplace hazardous materials information system regulations.

The band may comprise a diameter based on a diameter of the at least one hose, being sufficiently sized to fit about the periphery of the hose. The band may comprise various diameters. For example the band may comprise a diameter of 2 inches or 10 inches based on the size of the hose being identified. The band preferably comprising a light blue body with white writing identifies the at least one hose that has been flushed and is fresh. The band comprising a red the body identifies the at least one hose containing flammable substance. The band comprising a black and white print the body with white and black lettering identifies the at least one hose containing acid. Other color-coding indication means may be used and these have been provided for exemplary means.

A color of the body of the band is based on a primary class of the substance contained under current transportation of dangerous goods regulations. The bands identifying sour substances will be based on H2s percentages in three stages: A first-stage of H2s gas is 0.5% and equal to 5000 ppm. A second-stage of H2s gas is 0.51% to 10% and equal to 100000 ppm. A third-stage of H2s gas is 10.01%+.

The band identifying assembly is useful for identifying the at least one hose and regulating a hazardous substance residing in the at least one hose and to promote a safe work environment.

According to another embodiment, a method for using band identifying system is also disclosed herein. The method includes the steps of: step one, wrapping the band around at least one hose; step two, securing the band around at least one hose via the fastener; and step three, removing at least one band. Ready identification is then enabled.

The present invention holds significant improvements and serves as a band identifying system. Preferably, labeling means should provide efficient labeling means for identifying last contained substances in hoses and, yet would operate reliably and be manufactured at a modest expense. Thus, a need exists for a reliable band identifying system to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, band identifying system, constructed and operative according to the teachings of the present disclosure.

FIG. 1 shows a perspective view illustrating a band identifying system during an ‘in-use’ condition according to an embodiment of the disclosure.

FIG. 2 is a perspective view illustrating the band identifying system comprising a band identifying assembly according to an embodiment of the present invention of the disclosure.

FIG. 3 is a perspective view illustrating the band identifying assembly according to an embodiment of the present disclosure.

FIG. 4 is a perspective view illustrating the band identifying assembly according to an embodiment of the present disclosure.

FIG. 5 is a flow diagram illustrating a method of use for the band identifying system according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to labeling means and more particularly to a band identifying system as used to improve work environment safety during the transportation of various substances.

Generally speaking, LC Bandz or Last Contained Bandz Hose Hazard Identifiers Placard or containment colored bands use the current up to date TDG regulations along with generic bands that would comply with WHMIS and government standards and code. Bands are rubber with a watch like clip or like a snap back hat pin hole securement. For example light blue main with white lettering reading fresh or flushed. Red bands with white lettering are used for indicating flammable; black and white scheme used for acid with black and white lettering. Sour has bands with a greater than or less than percentage of H2s content last contained. Identification is broken into 3 stages: >0.5% or equal 5000 ppm; 0.51% to >10% or 100000 ppm; and 10.01%+. The present invention may be applied to all hoses at any and all work sites that have hoses that may or may not contain residue. Work place areas may include gas plants, compressor sites, fracking locations, batteries, satellite, etc.

The size of the hose determines the size of bands applied. Standard hose sizing ranges from 2″-4″ but other sizes may be used. Color of bands will be dependent on the Primary class of the product last contained under current TDG regulations. The UN# will classify the specific product under the TDG regulations ex. 1267, petroleum crude oil, 1230 Methanol, etc.

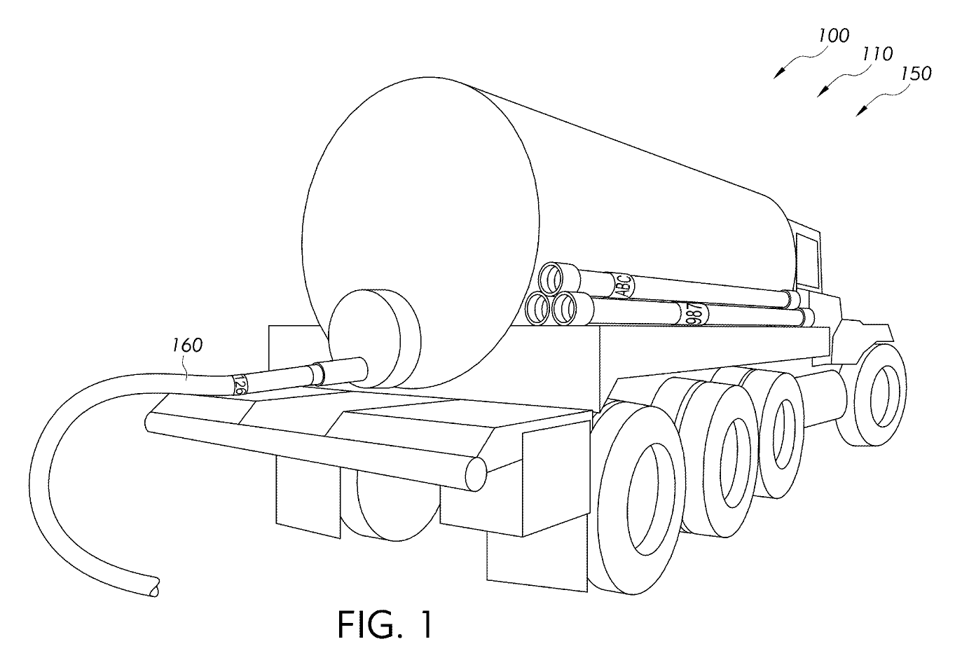

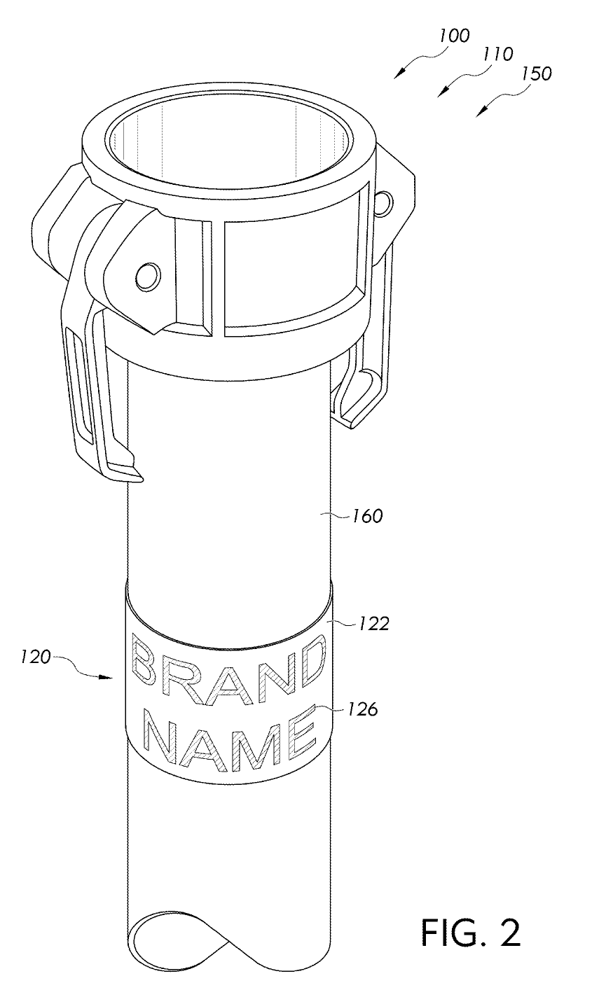

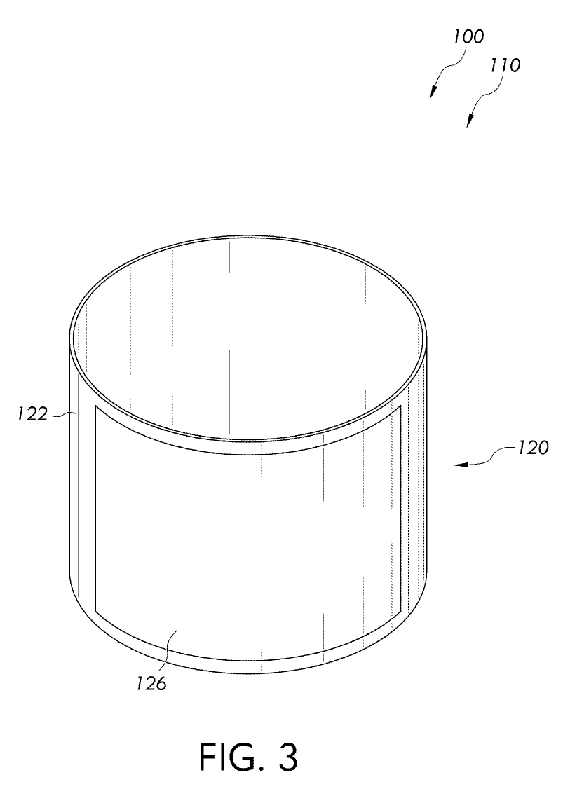

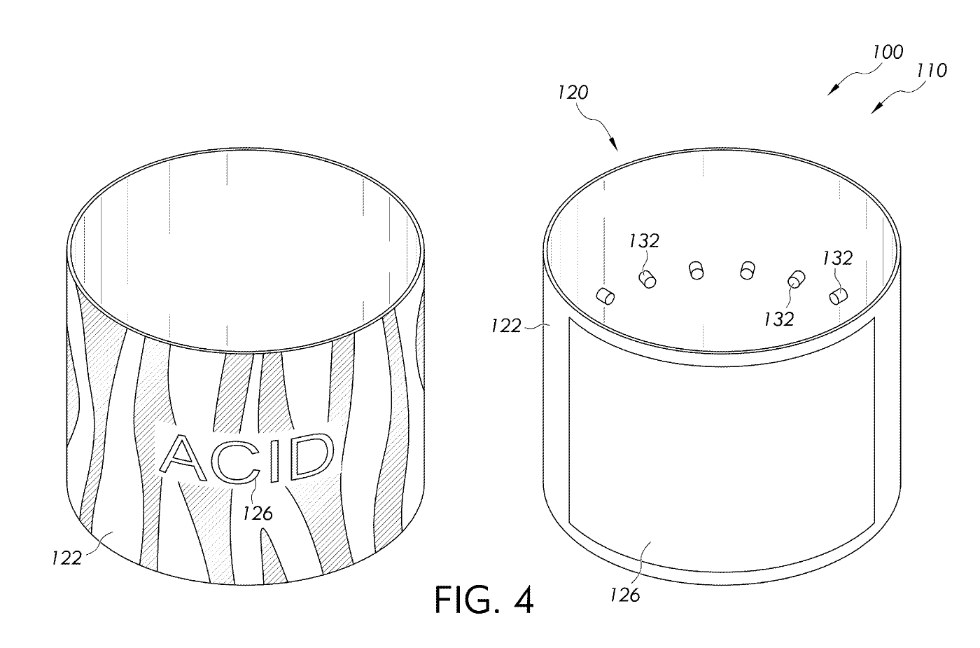

Referring now more specifically to the drawings by numerals of reference there is shown in FIGS. 1-4, various views of band identifying system 100 comprising: band identifying assembly 110 having band 120, label 126, and fastener 132. Band identifying system 100 comprises band identifying assembly 110. Band identifying assembly 110 comprises band 120, label 126, and fastener 132. Label 126 is located on band 120 for readily identifying contents of at least one hose 160. Fastener 132 is configured to wrap around at least one hose 160. Band identifying assembly 110 is useful for identifying at least one hose 160 and regulating a hazardous substance residing in the at least one hose and thus promote a safe work environment.

Band identifying assembly 110 identifies the hazardous substance and shows a last contained and currently contained substance. Band identifying assembly 110 follows transportation of dangerous goods regulations to promote safety when the dangerous goods are being handled. Band identifying assembly 110 complies with workplace hazardous materials information system regulations. Fastener 132 comprises a watch-like clip. Fastener 132 comprises pin hole securement. Band 120 comprises a diameter based on a diameter of at least one hose 160.

Band 120 comprising a light blue body 122 with white writing identifies at least one hose 160 that has been flushed and is fresh. Band 120 comprising a red body 122 identifies at least one hose 160 containing flammable the substance. Band 120 comprising a black and white print body 122 with white and black lettering identifies at least one hose 160 containing acid. A color of body 122 of band 120 is based on a primary class of the substance contained under current transportation of dangerous goods regulations. Bands 120 identifying sour substances will be based on H2s percentages in three stages: First-stage of H2s gas is 0.5% and equal to 5000 ppm. Second-stage of H2s gas is 0.51% to 10% and equal to 100000 ppm. Third-stage of H2s gas is 10.01%+. Band 120 comprises a minimum diameter of 2 inches and a maximum diameter of 4 inches

Band identifying system 100 may be sold as a kit comprising the following parts: at least one band 120; and at least one set of user instructions. The kit has instructions such that functional relationships are detailed in relation to the structure of the invention (such that the invention can be used, maintained, or the like in a preferred manner).

Band identifying system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

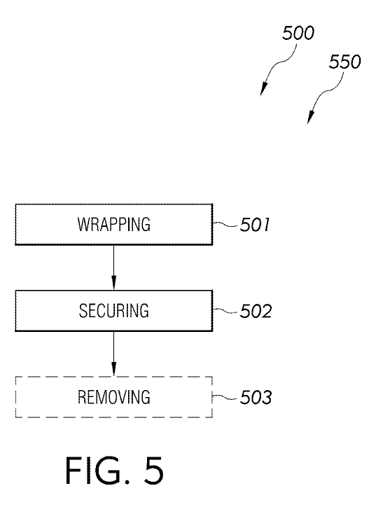

Referring now to FIG. 5 showing a flow diagram 550 illustrating method of use 500 for band identifying system 100 according to an embodiment of the present invention of FIGS. 1-4. As shown, method of use 500 may comprise the steps of: step one 501, wrapping at least one band 120 around at least one hose 160; step two 502, securing band 120 around at least one hose 160 via fastener 132; and step three 503, removing at least one band 120.

It should be noted that step three 503 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1) A band identifying system comprising:
a) a safety-marker-hose-band identifying assembly structured and arranged for individually identifying by color and by words a last contained substance and currently contained substance within each of at least three hoses, comprising:
i) at least three colored-safety-marker-hose-bands comprising:
a flushed-fresh-hose safety-marker-hose-band structured and arranged to wrap around a flushed-fresh-hose and comprising a light blue flushed-fresh-hose safety-marker-hose-band body and a white flushed-fresh-hose safety-marker-hose-band writing;
a flammable-substance-hose safety-marker-hose-band structured and arranged to wrap around a flammable-substance-hose and comprising a red flammable-substance-hose safety-marker-hose-band body and white flammable-substance-hose safety-marker-hose-band writing; and
an acid-containing-hose safety-marker-hose-band structured and arranged to wrap around an acid-containing-hose and comprising a black acid-containing-hose safety-marker-hose-band body and white acid-containing-hose safety-marker-hose-band writing;
ii) at least three labels comprising:
a flushed-fresh-hose safety-marker-hose-band label comprising flushed-fresh-hose white writing on a light blue body structured and arranged with said flushed-fresh-hose safety-marker-hose-band for displaying a last contained and currently contained substance in said flushed-fresh-hose wherein said flushed-fresh-hose white writing comprises a word from the following list, fresh or flushed;
a flammable-substance-hose safety-marker-hose-band label comprising flammable-substance-hose white writing on a red body structured and arranged with said flushed-fresh-hose safety-marker-hose-band for displaying a last contained and currently contained substance in said flammable-substance-hose wherein said flammable-substance-hose white writing comprises the word flammable; and
an acid-containing-hose safety-marker-hose-band label comprising acid-containing-hose white writing on a black body structured and arranged with said flushed-fresh-hose safety-marker-hose-band for displaying a last contained and currently contained substance in said acid-containing-hose wherein said acid-containing-hose white writing comprises the word acid;
iii) at least three fasteners structured and arranged to fasten to at least two different diameter hoses; and
f) wherein said band identifying assembly is useful for identifying said at least three hoses and regulating a hazardous substance residing in said at least three hoses and promote a safe work environment.

2) The band identifying system of claim 1 wherein said band identifying assembly identifies said hazardous substance and shows a last contained and currently contained substance.

3) The band identifying system of claim 1 wherein said band identifying assembly follows transportation of dangerous goods regulations to promote safety when said dangerous goods are being handled.

4) The band identifying system of claim 1 wherein said band identifying assembly complies with workplace hazardous materials information system regulations.

5) The band identifying system of claim 1 wherein said fastener comprises a clip.

6) The band identifying system of claim 1 wherein said fastener comprises pin hole securement.

7) The band identifying system of claim 1 wherein said at least three colored-safety-marker-hose-bands comprises a diameter based on a diameter of said at least one hose.

8) (canceled)

9) (canceled)

10) (canceled)

11) The band identifying system of claim 1 wherein a color of said at least three colored-safety-marker-hose-bands is based on a primary class of said substance contained under current transportation of dangerous goods regulations.

12) The band identifying system of claim 1 wherein said at least three colored-safety-marker-hose-bands identifying sour substances will be based on H2S percentages in three stages.

13) The band identifying system of claim 12 wherein a first-stage of H2S gas is 0.5% and equal to 5000 ppm.

14) The band identifying system of claim 12 wherein a second-stage of H2S gas is 0.51% to 10% and equal to 100000 ppm.

15) The band identifying system of claim 12 wherein a third-stage of H2S gas is 10.01%+.

16) The band identifying system of claim 1 wherein said at least three colored-safety-marker-hose-bands comprises various diameters.

17) A band identifying system comprising:
a) a safety-marker-hose-band identifying assembly structured and arranged for individually identifying by color and by words a last contained substance and currently contained substance within each of at least three hoses, comprising:
i) at least three colored-safety-marker-hose-bands comprising:
a flushed-fresh-hose safety-marker-hose-band structured and arranged to wrap around a flushed-fresh-hose and comprising a light blue flushed-fresh-hose safety-marker-hose-band body and a white flushed-fresh-hose safety-marker-hose-band writing;
a flammable-substance-hose safety-marker-hose-band structured and arranged to wrap around a flammable-substance-hose and comprising a red flammable-substance-hose safety-marker-hose-band body and white flammable-substance-hose safety-marker-hose-band writing; and
an acid-containing-hose safety-marker-hose-band structured and arranged to wrap around an acid-containing-hose and comprising a black acid-containing-hose safety-marker-hose-band body and white acid-containing-hose safety-marker-hose-band writing;
ii) at least three labels comprising:
a flushed-fresh-hose safety-marker-hose-band label comprising flushed-fresh-hose white writing on a light blue body structured and arranged with said flushed-fresh-hose safety-marker-hose-band for displaying a last contained and currently contained substance in said flushed-fresh-hose wherein said flushed-fresh-hose white writing comprises a word from the following list, fresh or flushed;
a flammable-substance-hose safety-marker-hose-band label comprising flammable-substance-hose white writing on a red body structured and arranged with said flushed-fresh-hose safety-marker-hose-band for displaying a last contained and currently contained substance in said flammable-substance-hose wherein said flammable-substance-hose white writing comprises the word flammable; and
an acid-containing-hose safety-marker-hose-band label comprising acid-containing-hose white writing on a black body structured and arranged with said flushed-fresh-hose safety-marker-hose-band for displaying a last contained and currently contained substance in said acid-containing-hose wherein said acid-containing-hose white writing comprises the word acid;
iii) at least three fasteners structured and arranged to fasten to at least two different diameter hoses; and
e) wherein said fastener is configured to wrap around said at least one hose;
f) wherein said fastener comprises a clip;
h) wherein said band identifying assembly follows transportation of dangerous goods regulations to promote safety when said dangerous goods are being handled;
i) wherein said band identifying assembly complies with workplace hazardous materials information system regulations;
o) wherein a color of said body of said band is based on a primary class of said substance contained under current transportation of dangerous goods regulations;
p) wherein said bands identifying sour substances will be based on H2S percentages in three stages;
q) wherein a first-stage of H2S gas is 0.5% and equal to 5000 ppm;
r) wherein a second-stage of H2S gas is 0.51% to 10% and equal to 100000 ppm;
s) wherein a third-stage of H2S gas is 10.01%+; and
t) wherein said band identifying assembly is useful for identifying said at least one hose and regulating a hazardous substance residing in said at least one hose and promote a safe work environment.

18) The band identifying system of claim 17 further comprising a kit including:
(a) said at least one band; and
(b) a set of user instructions.

19) A method of using the band identifying system of claim 17 comprising the steps of:
(a) wrapping at least one band around at least one hose; and
(b) securing said band around said at least one hose via fastener.

20) The method of claim 19 further comprising the steps of:
(a) removing said at least one band.
